(19) United States
(12) Patent Application Publication
(10) Pub. No.: US 2018/0001715 A1
(43) Pub. Date: Jan. 4, 2018

(54) TIRE TREAD FOR REDUCING NOISE

(71) Applicants: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(72) Inventor: Takashi TEZUKA, Tokyo (JP)

(73) Assignees: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(21) Appl. No.: 15/539,638

(22) PCT Filed: Dec. 17, 2015
(86) PCT No.: PCT/JP2015/086150

§ 371 Date: Jun. 23, 2017

(30) Foreign Application Priority Data
Dec. 26, 2014 (JP) PCT/JP2014/084760

(51) Int. Cl. B60C 11/13; B29C 33/12; B60C 11/03

(52) U.S. Cl. CPC B60C 11/1369; B29C 33/123; B60C 11/1353; B60C 2011/0351; B60C 2011/0348

(57) ABSTRACT

Present disclosure provide a tread for a tire having a plurality of grooves formed in the tread, a plurality of contact elements delimited by a plurality of grooves and having circumferential surfaces, transverse surfaces and a contact surface intended to come into contact with ground during rolling, the contact element having a height H, and at least one connecting member connecting the transverse surface of the contact element to the transverse surface of the circumferentially adjacent contact element, a distance h between one of the connecting members and the contact face is at most equal to 30% of the height H, and a material of the connecting member is different from a material of the contact element, and a Young modulus of the material of the connecting member is higher than a Young modulus of the material of the contact element.

### CROSS-REFERENCE TO RELATED APPLICATIONS

This application is a 371 national phase entry of PCT/JP2015/086150, filed 17 Dec. 2015, which claims the benefit of PCT Patent Application No. PCT/JP2014/084760, filed 26 Dec. 2014, the contents of which are incorporated herein by reference for all purposes.

### BACKGROUND

In recent years, premiumisation and quality improvement of vehicles lead, from the view point of occupant's comfort and environmental considerations, desire to various noise reductions, in particular pass-by noise.

When a contact element on a tread of a tire enters to or exits from a contact patch during rolling, the tread is forced to be bent due to flattening. At this stage, geometrical discontinuity due to existence of periodical grooves extending in an axial direction which leads inhomogeneity of a bending stiffness of the tread in a circumferential direction, excites internal construction of the tire to generate noise.

In order to reduce such inhomogeneity of the bending stiffness of the tread in a circumferential direction, it is known that reduction of a volume of the groove extending in an axial direction is effective. However, it is also known that reduction of the volume of the groove extending in an axial direction penalizes hydroplaning performance of the tread. Thus, there is a need to improve noise performance while maintaining hydroplaning performance. In response to such need, following arrangement has been proposed.

JP1995-329511A discloses, in FIG. 5, a pneumatic tire having a plurality of reinforcing elements extending in a lateral groove alternately from two opposed contact elements, and reinforcing element having an overlapping each other.

JP2011-255716A discloses, in FIG. 2 a pneumatic tire having a bridge-like reinforcing portion at a position closer to a tread surface and having a cavity at a position closer to a groove bottom.

JP2001-511733A discloses, in FIG. 1, a pneumatic tire tread having a connecting element made of rubber and connecting two opposed main walls.

The above arrangements intend to reduce inhomogeneity of the bending stiffness in the tread for reducing the noise, while maintaining the volume of groove to achieve satisfactory hydroplaning performance.

However, with the above arrangements, the ratio of the volume of the reinforcing element or portion (or connecting member) relative to the volume of groove has been still large to obtain satisfactory hydroplaning performance. Therefore, it is difficult to obtain satisfactory hydroplaning performance simultaneously with satisfactory noise performance.

### Definitions

A “groove” is a space between two rubber faces/sidewalls which do not contact between themselves under usual rolling condition connected by another rubber face/bottom. A groove has a width and a depth.

A “radial direction” is a direction perpendicular to an axis of rotation of a tire. This direction is the direction of the thickness of a tread.

A “transverse direction” or an “axial direction” is a direction parallel to an axis of rotation of a tire.

A “circumferential direction” is a direction tangent to any circle centered on an axis of rotation of a tire. This direction is perpendicular to both the radial direction and the transverse direction.

A “contact patch” is a footprint of a tire mounted onto its standard rim as identified in tire standards such as ETRTO, JATMA or TRA, and inflated at its nominal pressure and under its nominal load.

It is thus an object of the disclosure to provide a solution for designing a tread for a tire, said tread having the connecting member connecting a transverse surfaces of a contact element for noise performance improvement while maintaining hydroplaning performance.

### SUMMARY

The present disclosure relates to a tread for a tire and in particular to a tread having a connecting member between two adjacent contact elements for reducing noise, and to a tire having such tread.

The present disclosure provide a tread for a tire having a plurality of grooves formed in the tread, a plurality of contact elements delimited by a plurality of grooves and having circumferential surfaces, transverse surfaces and a contact surface intended to come into contact with ground during rolling, the contact element having a height H, and at least one connecting member connecting the transverse surface of the contact element to the transverse surface of the circumferentially adjacent contact element, a distance h between one of the connecting members and the contact face is at most equal to 30% of the height H, and a material of the connecting member is different from a material of the contact element, and a Young modulus of the material of the connecting member is higher than a Young modulus of the material of the contact element.

This arrangement permits having homogeneous distribution of the bending stiffness of the tread in circumferential direction which results noise performance improvement while maintaining hydroplaning performance.

Since the connecting member is made of the material different from the material constituting the contact element and having higher Young modulus than the material constituting the contact element, inhomogeneity of the bending stiffness of the tread in circumferential direction is drastically decreased. As a result, excitation of internal construction of the tire is reduced, thus noise generated during rolling of the tire is also reduced.

At the same time, higher Young modulus of the material constituting the connecting member than that of the material constituting the contact elements allows to efficiently reduce inhomogeneity of the bending stiffness of the tread in circumferential direction. As a result, the connecting member does not substantially reduce the volume of the groove and thus hydroplaning performance can be maintained.

By setting the distance h between at least one connecting member and the contact face to at most equal to 30% of the height H of the contact element, the connecting member can be located far enough from the groove bottom for efficiently reducing inhomogeneity of the bending stiffness of the tread in circumferential direction, which results further less volume of the connecting member in the groove, thus hydroplaning performance can be maintained further. The distance h is preferably at most equal to 20% of the height H of the contact element, more preferably at most equal to 15%.

In another advantageous embodiment, the Young modulus of the material of the connecting member is within the range of 0.05 GPa to 250 GPa.

According to this arrangement, bending stiffness variation of the tread in circumferential direction can be efficiently controlled. As a result, noise level emitted from the tread can be decreased.

If this Young modulus is less than 0.05 GPa, rigidification of the tread at the groove becomes insufficient, thus noise performance will not be sufficiently improved. If this Young modulus is more than 250 GPa, the bending stiffness of the tread at the groove becomes too high and another bending stiffness variation of the tread in circumferential direction will be created, thus noise performance improvement cannot be achieved.

The Young modulus of the material constituting the connecting member is preferably in a range of 0.1 GPa to 150 GPa, more preferably in range of 0.5 GPa to 3 GPa.

In another advantageous embodiment, a ratio of a volume occupied by the connecting member relative to a volume of the groove between the circumferentially opposing transverse surfaces of the circumferentially adjacent contact elements, is less than or equal to 10%.

According to this arrangement, hydroplaning performance of the tread is maintained even though such tread is provided with the connecting member in the groove for improving noise performance.

If the ratio is more than 10%, hydroplaning performance of the tread is deteriorated. The ratio is preferably at most equal to 8%, more preferably is in a range of 0.1% to 5%.

In another advantageous embodiment, at most equal to five connecting members are provided on one transverse surface of the contact element.

According to this arrangement, noise performance improvement and manufacturing efficiency of the tread are well-balanced. If the number of the connecting member on one transverse surface is more than five, manufacturing efficiency of the tread will decrease. The number of the connecting member on one transverse surface is preferably at most equal to three.

In another advantageous embodiment, a connecting member extends in a direction at an angle less than or equal to 30 degrees relative to a circumferential direction.

According to this arrangement, a force tangent to the connecting member can be minimized and thus the noise from the tread is efficiently reduced. The above angle of the connecting member relative to a circumferential direction is preferably at most equal to 20 degrees, and more preferably at most equal to 10 degrees, and still more preferably in a range of 0 degree to 5 degrees.

In another advantageous embodiment, two ends of the connecting member are embedded into the contact element at a length C from the transverse surface, which length is shorter than the half of a circumferential length L of the contact element.

According to this arrangement, inhomogeneity of the bending stiffness of the tread can be reduced. At the same time, the connecting member can sufficiently resist against the pullout force from the contact element. As a result, endurance performance is improved while improving the noise performance at the same time.

In another advantageous embodiment, one end of one connecting member is inserted into the contact element through its one transverse surface and one end of another connecting member is inserted into said contact element through its circumferentially opposite transverse surface, and portions of one and another connecting members inserted in said contact element partly three-dimensionally overlaps, such that the contact member includes an axial cross section in which the one and another connecting members exist.

According to this arrangement, stronger resistance against pullout force from the transverse surface is obtained, while improving the noise performance at the same time.

In another advantageous embodiment, the connecting member extends continuously through two transverse surfaces of the same contact element.

According to this arrangement, the tread with the connecting member can be efficiently manufactured.

### BRIEF DESCRIPTION OF THE DRAWINGS

Other characteristics and advantages of the disclosure arise from the description made hereafter in reference to the annexed drawings which show, as nonrestrictive examples, the embodiments of the object of the disclosure.

In these drawings:

FIG. 1 is a schematic plan view of a tread according to a first embodiment of the present disclosure;

FIG. 2 is an enlarged schematic perspective view showing a portion indicated as II in FIG. 1;

FIG. 3 is a cross sectional view taken along III-III line in FIG. 2;

FIG. 4 is a cross sectional view of a tread according to a second embodiment of the present disclosure;

FIG. 5 is a cross sectional view of a tread according to a third embodiment of the present disclosure;

FIG. 6 is a cross sectional view of a tread according to a forth embodiment of the present disclosure;

FIG. 7 is a schematic plan view of a tread according to a fifth embodiment of the present disclosure.

### DETAILED DESCRIPTION

Preferred embodiments of the present disclosure will be described below referring to the drawings.

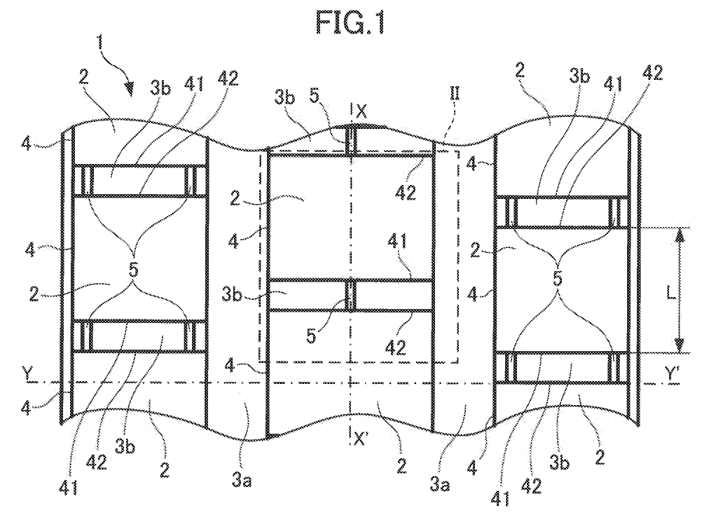

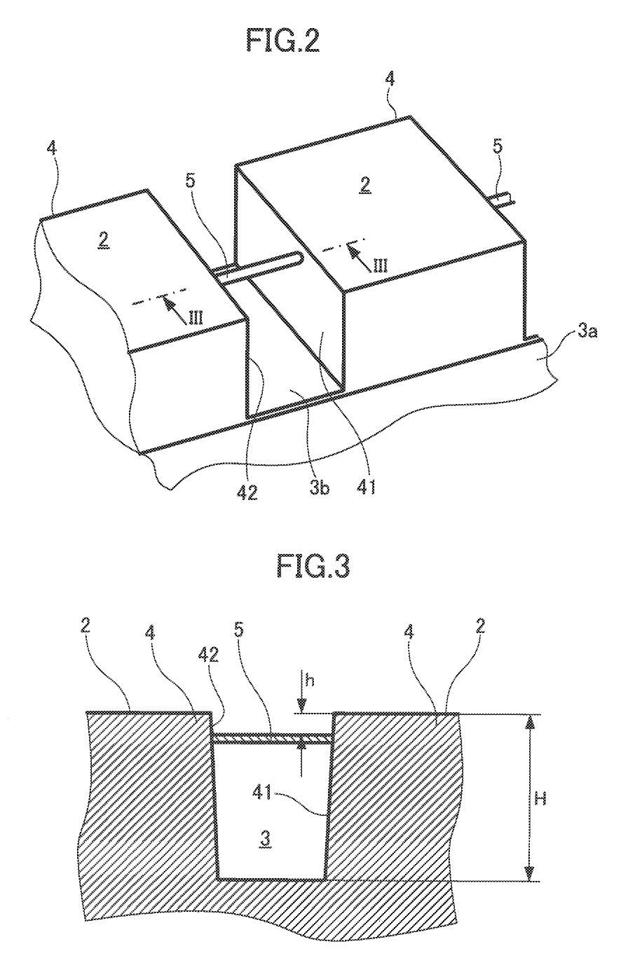

A tread 1 for tires according to a first embodiment of the present disclosure will be described referring to FIGS. 1, 2 and 3. FIG. 1 is a schematic plan view of a tread 1 according to a first embodiment of the present disclosure. FIG. 2 is an enlarged schematic perspective view showing a portion indicated as II in FIG. 1. FIG. 3 is a cross sectional view taken along III-III line in FIG. 2.

The tread 1 is a tread for a tire having dimension 205/55R16 and comprises a plurality of two circumferential grooves 3a extending in a tire circumferential direction indicated as XX′ and axial grooves 3b extending in a generally tire axial direction indicated as YY′.

As shown in FIG. 1, a plurality of contact elements 4 having generally rectangular parallelepiped are formed in the tread 1. The contact element 4 is delimited by the circumferential grooves 3a in a circumferential direction and is delimited by axial grooves 3b in an axial direction. Thus, the contact element 4 has two transverse surfaces 41, 42 facing opposite circumferential directions. Distance between the above two transverse surfaces 41, 42 corresponds to circumferential length L of the contact element 4. In the present embodiment, the circumferential length L is 30 mm.

Adjacently arranged contact elements 4 in a circumferential direction are separated in a circumferential direction by the axial groove 3b. The contact element 4 has a contact face 2 intended to come into contact with ground during rolling at the top portion thereof.

The tread 1 has the same structure as the conventional tread except for an arrangement regarding the connecting member 5 and is intended to be applied to a conventional pneumatic radial tire. Thus, description of the internal construction of the tread 1 will be omitted.

Between two circumferentially adjacent contact elements 4, a connecting member 5 having a thin rod-like shape, is provided. The connecting member 5 extends across the axial groove 3b between two circumferentially adjacent contact elements 4, as shown in FIGS. 1 and 2.

In the present embodiment, one connecting member 5 is provided between circumferentially adjacent contact elements 4 in axially central region in the tread 1. That is, in axially central area, circumferentially adjacent contact elements 4 are connected by one connecting member 5.

On the other hand, two connecting members 5 are provided between circumferentially adjacent contact elements 4 in axially outward regions in the tread 1. That is, in axially outward areas, circumferentially adjacent contact elements 4 are connected by two connecting members 5. Two connecting members 5 positioned at the same radial position.

In the present embodiment, the connecting members 5 are arranged so as to extend substantially along the circumferential direction maintaining the same distance from the rotation axis of the tire. That is, the connecting members 5 extend in parallel to the contact face 2.

A number of connecting members 5 on one transverse surface 41, 42 can be changed in a range of one to five.

Each the connecting member 5 extends along the circumferential groove 3a, thus an angle of an extending direction of the connecting member 5 relative to tire circumferential direction is 0 degree.

The contact element 4 has a height (radial length) H, as shown FIG. 3. A radial distance B between the connecting member 5 and the contact face 2 is equal to or less than 30% of the height H. In the present embodiment, the height H is 7.5 mm and the distance h is 2 mm, thus the distance h is 27% of the height H.

A material constituting the connecting member 5 is different from a material constituting the contact element 4, and a Young modulus of the material constituting the connecting member 5 is higher than a Young modulus of the material constituting the contact element. In the present case, the connecting member 5 is made of a metal cord (160 GPa in Young modulus), and the contact element 4 is made of a rubber composition (0.02 GPa in Young modulus).

The connecting member 5 occupies at most equal to 10% of a volume of the axial groove 3b defined or formed between two transverse surfaces 41, 42 spaced apart in tire circumferential direction. In the present case, the connecting member 5 occupies 1.4% of the axial groove 3b by volume in case one connecting member 5, 2.8% in case of two connecting members 5.

In the present embodiment, opposite ends of the connecting member 5 is connected to the transverse surfaces 41, 42 of the contact element 4 by adhesion and does not penetrate into the contact element 4.

In the arrangement of the first embodiment, inhomogeneity of the bending stiffness of the tread 1 in circumferential direction can be drastically decreases, which results less excitation of internal construction of the tire. Thus, noise generated during rolling of the tire can be reduced.

The Young modulus of the material constituting the connecting member 5 is preferably within the range of 0.1 GPa to 150 GPa, more preferably within the range of 0.5 GPa to 3 GPa.

Higher Young modulus of the material constituting the connecting member 5 than that of the material constituting the contact elements 4 allows to efficiently reduce inhomogeneity of the bending stiffness of the tread 1 in circumferential direction, which leads less volume of the connecting member in the axial groove 3b. Thus, hydroplaning performance can be maintained.

This effect is further emphasized by setting the ratio of a volume occupied by the connecting member 5 relative to a volume of the axial groove 3b between the circumferentially opposing transverse surfaces 41, 42 of the circumferentially adjacent contact elements 4, to at most equal to 10%.

The above ratio is preferably at most equal to 8%, more preferably at least equal to 0.1% and at most equal to 5%.

By setting the distance h between the connecting member 5 and the contact face 2 to 30% or less than 30% of the height H of the contact element 4, the connecting member 5 is placed far enough from the groove bottom for efficiently reducing inhomogeneity of the bending stiffness of the tread 1 in circumferential direction.

In case less distance h is set, the less number of connecting members are required to obtain the same inhomogeneity of the bending stiffness of the tread 1 in circumferential direction. According to the above arrangement in which the connecting member is placed near the contact surface, the inhomogeneity of the bending stiffness of the tread 1 in circumferential direction can be obtained by less number or less volume of connecting members 5. Thus, volume of the connecting member 5 in the axial groove 3b can be reduced resulting that hydroplaning performance is maintained.

Since the number of the connecting members 5 on one transverse surface 41, 42 is selected in a range of one to five, noise performance improvement and manufacturing efficiency are well balanced in the tread 1.

The number of the connecting member 5 on one transverse surface 41, 42 is more preferably in a range of one to three.

The material usable for the connecting member 5 is, for example, thermoplastic material such as acrylonitrile butadiene styrene copolymer, cellulose acetate, polyamide, Kevlar (trademark), polycarbonate, poly-ether-ether-ketone, polyethylene terephthalate, polystyrene, thermoplastic polyurethane, thermoset material such as epoxy, phenolic, polyester, ebonite, metal material such as steel, brass, and composite material with reinforcements such as carbon fiber, glass fiber, aramid fiber, PET, nylon, vegetal fiber in a form of cord, cable, short fiber or wire. A structure of such cord, cable, short fiber or wire may be monofilament, multifilament or multi-component filament.

The connecting member 5 may be covered with the same material constituting the contact element 4 for better adhesion to the transverse surfaces 41, 42 of the contact element 4. Other material having better adhesion with the material constituting the contact element 4 can be used for a material for covering the connecting member 5.

In case two or more connecting members 5 are provided on one transverse surface 41, 42, each connecting member 5 may be constituted by different material.

Further, in this case, radial position of each connecting member 5 on the transverse surfaces 41, 42 may be different.

The connecting member 5 may be placed at axially center of the contact element 4 or at axially outward or inward of the contact element 4.

Alternatively, the connecting member 5 may be covered with the same material constituting the contact element 4 which material preferably extends from bottom of the axial groove 3b toward the contact face 2 of the contact element 4 for better endurance of the connecting member 5.

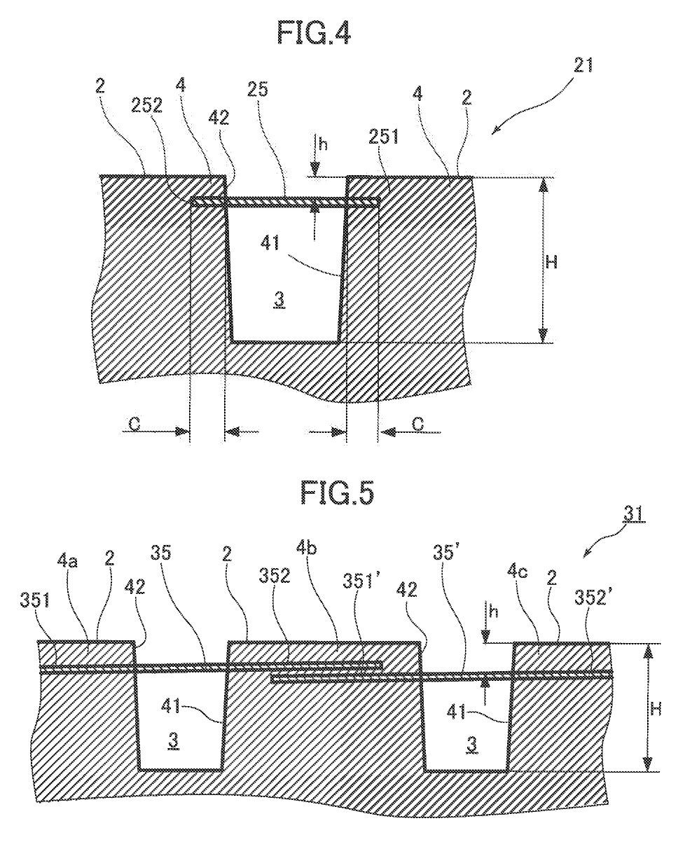

A tire tread 21 according to a second embodiment of the present disclosure will be described referring to FIG. 4. FIG. 4 is a cross sectional view of the second embodiment of the present disclosure. The constitution of this second embodiment is similar to that in the first embodiment other than the arrangement shown in FIG. 4, thus description will made on the basis of FIG. 4.

In the second embodiment, opposite ends 251, 252 of the connecting member 25 are inserted or embedded into the contact elements 4 through the transverse surfaces 41, 42 of the contact elements 4 arranged in circumferential direction.

In the second embodiment, the length of the portion inserted into the contact element 4 has length C, which length is shorter than half of a circumferential length L of the contact element 4. In the second embodiment, the circumferential length C is 5 mm.

By providing an area without any connecting members 25, the reduced inhomogeneity of the bending stiffness of the tread is obtained. In addition, resistance against the pullout force of the connecting member 25 from the contact element 4 is enhanced, thus endurance performance will increase while improving the noise performance at the same time.

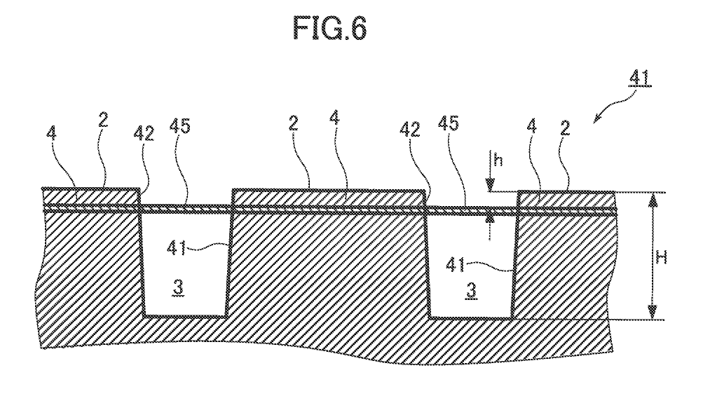

A tire tread 31 according to a third embodiment of the present disclosure will be described referring to FIG. 5. FIG. 5 is a cross sectional view of the third embodiment of the present disclosure. The constitution of this third embodiment is similar to that in the first embodiment other than the arrangement shown in FIG. 5, thus description will made on the basis of FIG. 5.

In the third embodiment, opposite ends 351, 352 of the connecting member 35 are inserted or embedded into the contact elements 4a, 4b through the transverse surfaces 41, 42 of the contact elements 4a, 4b arranged in circumferential direction. Further, opposite ends 351′, 352′ of another connecting member 35′ are inserted or embedded into the contact element 4b, 4c, which contact element 4c is arranged in circumferentially opposite direction to the contact element 4a with respect to contact element 4b.

That is, one end portion 352 of one connecting member 35 is inserted into the contact element 4b through its one transverse surface 41 facing one circumferential direction and one end portion 351′ of another connecting member 35′ is inserted into the contact element 4b through its circumferentially opposite transverse surface 42, as shown in FIG. 5. An end portion 352 of one connecting member 35 inserted into the contact element 4b, radially overlaps the end portion 351′ of another connecting members 35′ inserted into the contact element 4b. That is, the end portions 352, 351′ three-dimensionally overlaps.

Alternatively, the end portions of the two connecting member 35, 35′ may three-dimensionally overlaps in other direction, such that the contact member includes an axial cross section in which the end portions 352, 351′ exist.

The radially overlapping portion of the connecting member 35, 35′ provide stronger resistance against pullout force of the connecting member 35, 35′ from the contact element 4, thus endurance performance will increase while improving the noise performance.

A tire tread 41 according to a fourth embodiment of the present disclosure will be described referring to FIG. 6. FIG. 6 is a cross sectional view of the fourth embodiment of the present disclosure. The constitution of the fourth embodiment is similar to that in the first embodiment other than the arrangement shown in FIG. 6, thus description will made on the basis of FIG. 6.

In the fourth embodiment, one long connecting member 5 passes continuously through a plurality of contact elements 4 circumferentially arranged, as shown in FIG. 6.

In this embodiment, the tread 1 with the connecting member 5 is efficiently manufactured as there will be no need to apply individual connecting member 5 to each contact element 4.

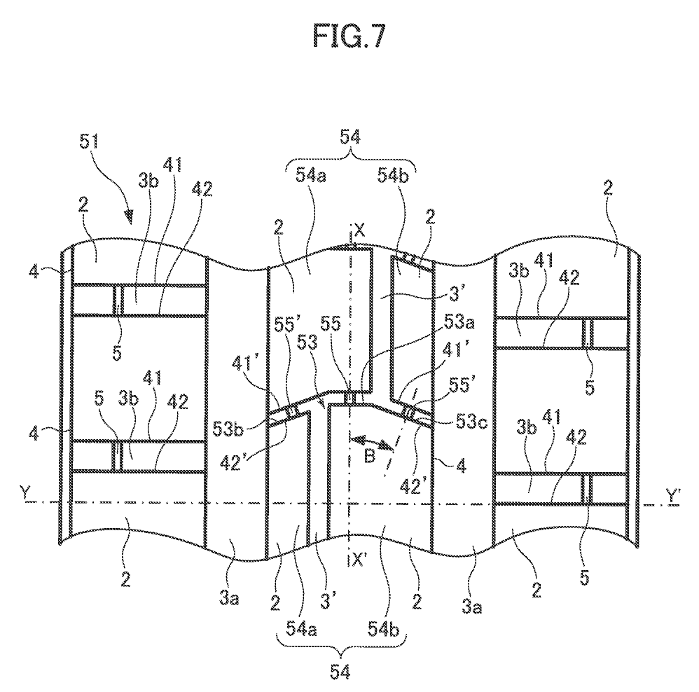

A tire tread 51 according to a fifth embodiment of the present disclosure will be described referring to FIG. 7. FIG. 7 is a plan view schematically showing the fifth embodiment of the disclosure.

The tread 51 according to the fifth embodiment comprises two circumferential grooves 3a and a plurality of axial grooves 3b formed in axially outward regions. The two circumferential grooves 3a extend in tire circumferential direction indicated as XX′ and the axial grooves 3b extend tire axial direction indicated as YY′.

In an axially central region of the tread 51, are provided oblique axial grooves 53 generally obliquely extending with respect to the axial direction. The circumferential grooves 3a and the oblique axial grooves 53 delimit central contact elements 54 in the axially central region. The central contact element 54 is further divided into two parts, that is, a left part 54a and a right part 54b by a narrow circumferential groove 3′. As shown in FIG. 7, the narrow circumferential grooves 3′ are arranged in staggered manner in the array of the central contact elements 54.

An axially central portion 53a of the oblique axial grooves 53 extends in an axial direction and both end portions 53b, 53c of the oblique axial grooves 53 extend in oblique direction with respect to the axial direction, respectively as shown in FIG. 7. Thus, in the axially outward portions of the central contact element 54, transverse surface 41′, 42′ obliquely extends relative to a tire axial direction. The oblique axial groove 53 has a boomerang-like shape.

As shown in FIG. 7, connecting members 55′ are provided as to connect two transverse surfaces 41′, 42′ of the adjacent central contact elements 54. In an axially central part of the central contact element 54, the connecting member 55 extending in circumferential direction connects left part 54a and right part 54b adjacently arranged in circumferential direction.

On the other hand, in an axially outward portions of the central contact element 54, the connecting member 55′ extends in a direction forming angle B relative to the tire circumferential direction.

Although in the fifth embodiment an angle B is set to 25 degrees, the angle B can vary in the range of 0 to 30 degrees.

According to the fifth embodiment shown in FIG. 7, it is possible to decrease inhomogeneity of the bending stiffness of the tread in circumferential direction thanks to the connecting member, which also reduces noise during rolling of the tire.

The angle B of the connecting members 55′ oblique to the tire circumferential direction minimize occurrence of a force tangent to the connecting member 55′ for both efficient noise reduction and better endurance of the connecting member. The angle B of the connecting member 55′ is preferably in a range of 0 to 20 degrees, and more preferably in a range of 0 to 10, and still more preferably in a range of 0 to 5 degrees.

In order to confirm the effect of the present disclosure, two types of tires of Example to which the present disclosure is applied and another type of tire of Comparative Example were prepared. An internal construction of these tires was typical radial tire construction for passenger car tire.

The Example 1 was a tire having a tread as shown in FIG. 4 described in the above embodiment using a metal cord (160 GPa in Young modulus) as material of connecting member, the Example 2 was the same tire as the Example 1 except use of a nylon cable (3 GPa in Young modulus) as material of connecting member. Each of two opposed transverse surfaces across the groove extending in tire axial direction was connected by one connecting member. The Comparative Example was a tire without having the connecting member and 70% volume of the groove extending in tire axial direction was filled from its bottom with a same rubber material constituting a contact element (a rubber bridge), and Reference was a tire without having the connecting member and the rubber bridge.

The tire dimension of the Examples, Comparative Example and Reference were all 205/55R16, mounted onto a rim of 6.5 J×16, and inflated to 180 kPa.

Noise Test:

A sound pressure level dB(A) of the unused test tires mounted onto abovementioned rim, inflated to abovementioned internal pressure were measured while applying a load of 452 daN, running 80 kph on a drum of 2.7 m in diameter having ISO surface in a semi-anechoic chamber, via a microphone installed axially 1 m outward from a center of tire contact, radially 0.2 m backward from a tire rolling axis and 0.32 m in height. The results are shown in table 1. In this table 1, results are represented by an index of 100 for the Reference, higher the number indicates better the noise performance.

TABLE 1

| | | | Comparative | |
|---|---|---|---|---|
| | Example 1 | Example 2 | Example | Reference |
| Noise | 110 | 113 | 108 | 100 |
| performance | | | | |
| (index) | | | | |
| Volume of | 1.4% | 4% | 70% | 0% |
| reinforcement | | | | |
| in axial groove | | | | |

As seen from table 1, the Example tires show improvement on noise performance while maintaining the volume of the groove extending tire axial direction which leads hydroplaning performance maintenance.

The disclosure is not limited to the examples described and represented and various modifications can be made there without leaving its framework.

The tread of the present disclosure can be used not only for a pneumatic tire but also for a tread portion of non-pneumatic tire such as a solid tire or a tire with flexible spokes (such as a non-pneumatic tire known under the trade name “TWEEL” (registered trade mark)).

1. A tread for a tire having a plurality of grooves formed in the tread, comprising:
a plurality of contact elements delimited by a plurality of grooves and having circumferential surfaces, transverse surfaces and
a contact surface that comes into contact with ground during rolling, each of the contact elements having a height H, and at least one connecting member connecting the transverse surface of each of the contact elements to the transverse surface of a circumferentially adjacent contact element,
wherein a distance h between one of the connecting members and the contact face is at most equal to 30% of the height H, and a material of the connecting member is different from a material of each of the contact element, and a Young modulus of the material of the connecting member is higher than a Young modulus of the material of the contact element.

2. The tread according to claim 1, wherein the Young modulus of the material of the connecting member is within the range of 0.05 GPa to 250 GPa.

3. The tread according to claim 1, wherein a ratio of a volume occupied by the connecting member relative to a volume of the groove between the circumferentially opposing transverse surfaces of the circumferentially adjacent contact elements, is less than or equal to 10%.

4. The tread according to 1, wherein at most equal to five connecting members are provided on one transverse surface.

5. The tread according to claim 1, wherein a connecting member extends in a direction at an angle less than or equal to 30 degrees relative to a circumferential direction.

6. The tread according to claim 1, wherein two ends of the connecting member are embedded into the contact element at a length C from the transverse surface, which length is shorter than the half of a circumferential length L of the contact element.

7. The tread according to claim 1, wherein one end of one connecting member is inserted into the contact element through its one transverse surface and one end of another connecting member is inserted into said contact element through its circumferentially opposite transverse surface, and portions of one and another connecting members inserted in said contact element partly three-dimensionally overlaps, such that the contact member-element includes an axial cross section in which the one and another connecting members exist.

8. The tread according to claim 1, wherein the connecting member extends continuously through two transverse surfaces of the same contact element.

9. (canceled)
